(19) United States
(12) Patent Application Publication
(10) Pub. No.: US 2015/0377726 A1
(43) Pub. Date: Dec. 31, 2015

(54) METHOD FOR INDENTIFYING FRICTION PARAMETER FOR LINEAR MODULE

(71) Applicant: HIWIN TECHNOLOGIES CORP., Taichung City (TW)

(72) Inventors: Meng-Shiun TSAI, Chia-Yi County (TW); Wei-Hsiang YUAN, New Taipei City (TW); Chih-Wei WANG, Taichung City (TW); Hong-Wei HUANG, Chia-Yi County (TW); Chung-Ching LIU, Chia-Yi County (TW)

(21) Appl. No.: 14/478,940

(22) Filed: Sep. 5, 2014

(30) Foreign Application Priority Data
Jun. 26, 2014 (TW) 103122131

(51) Int. Cl. G01L 5/00; G01P 3/00

(52) U.S. Cl. CPC G01L 5/00; G01P 3/00

(57) ABSTRACT

A method for identifying friction parameters for a linear module is disclosed. Since an acting interval of a friction is determined by a relative velocity between two contacting surfaces, and when the relative velocity is much greater than a Stribeck velocity, there is only a Coulomb friction and a viscous friction exist between the contacting surfaces, it is possible to use a measured torque signal of this interval to identify a Coulomb friction torque, a the linear module's friction torque, and the linear module's equivalent inertia. When the relative velocity between the two contacting surfaces is smaller than the Stribeck velocity, it is possible to identify a maximum static friction torque and the Stribeck velocity by referring to the three known parameters. Thereby, all the friction parameters can be identified within one reciprocating movement of the linear module, making the method highly feasible in practice.

### BACKGROUND OF THE INVENTION

1. Technical Field

The present invention relates to linear systems, and more particularly to a method for identifying friction parameters for linear module.

2. Description of Related Art

For automated equipment using ball screws, the automated equipment's accuracy of positioning mainly relies on the ball screw's preload that eliminates backlash in the ball screw and increase the rigidity of the ball screw. However, such preload inevitably increases friction between the contacting surfaces, and leads to quadrant errors when the screw shaft changes directions at a high speed, thereby affecting adversely the accuracy of the automated equipment.

For addressing this issue, a known approach involves using a LuGrefriction model to build up a relation curve between the friction torque and the velocity, and then identifying the relevant parameters by means of curve fitting. However, the use of the LuGrefriction model requires many times of fixed velocity friction tests, making this known approach greatly limited and thus less feasible in practice. In addition, in the process of performing curve fitting, since there are too many parameters remain unknown, the identification is quite difficult.

### BRIEF SUMMARY OF THE INVENTION

The primary objective of the present invention is to provide a method for identifying friction parameters for a linear module, which eliminates the use of multiple fixed velocity friction tests, so as to make the parameter-identifying process much easier and much more feasible in practice.

For achieving the foregoing objective, the disclosed method comprises three steps. The first step is to provide a parametric equation that is written as: Tₘ=Jα+T_{c}sgn(ω)+(Tₛ−T_{c})e^{-(ω/ω}^{ₛ}⁾^{²}sgn (ω)+σ₂ω, where Tₘ is the motor's output torque, J is the linear module's equivalent inertia, α is an angular acceleration of an output shaft of the motor, T_{c} is a Coulomb friction torque, ω is an angular speed of the output shaft of the motor, Tₛ is a maximum static friction torque, ωₛ is a Stribeck velocity, and σ₂ is a viscous friction coefficient. The second step is to use the parametric equation to obtain J, T_{c} and σ₂ when ω is much greater than ωₛ . Preferably, J, T_{c} and σ₂ can be identified by means of sinusoidal velocity planning or trapezoidal velocity planning. The third step is to identify Tₛ and ωₛ using the parametric equation with reference to the parameters identified in the second step when ω is lower than ωₛ. Preferably, Tₛ and ωₛ are identified by means of curve fitting. Alternatively, the parametric equation is converted into a linear equation for identifying Tₛ and ωₛ. The linear equation is p=q−ω²·r, where p is ln(Tₘ−Jα−T_{c}sgn(ω)−σ₂ω), and q is ln(Tₛ−T_{c}), r is 1/(ωₛ)².

Thereby, the disclosed method divides the linear module's moving velocity into a high-speed segment interval and a low-speed segment interval, so that all the relevant parameters can be identified during the linear module's one reciprocating movement, so as to make the parameter-identifying process much easier and much more feasible in practice.

### BRIEF DESCRIPTION OF THE SEVERAL VIEWS OF THE DRAWINGS

FIG. 1 is a flowchart of a method for identifying a friction parameter for linear module according to the present invention.

FIG. 2 graphically illustrates sinusoidal velocity planning performed in the present invention.

FIG. 3 graphically illustrates trapezoidal velocity planning performed in the present invention.

### DETAILED DESCRIPTION OF THE INVENTION

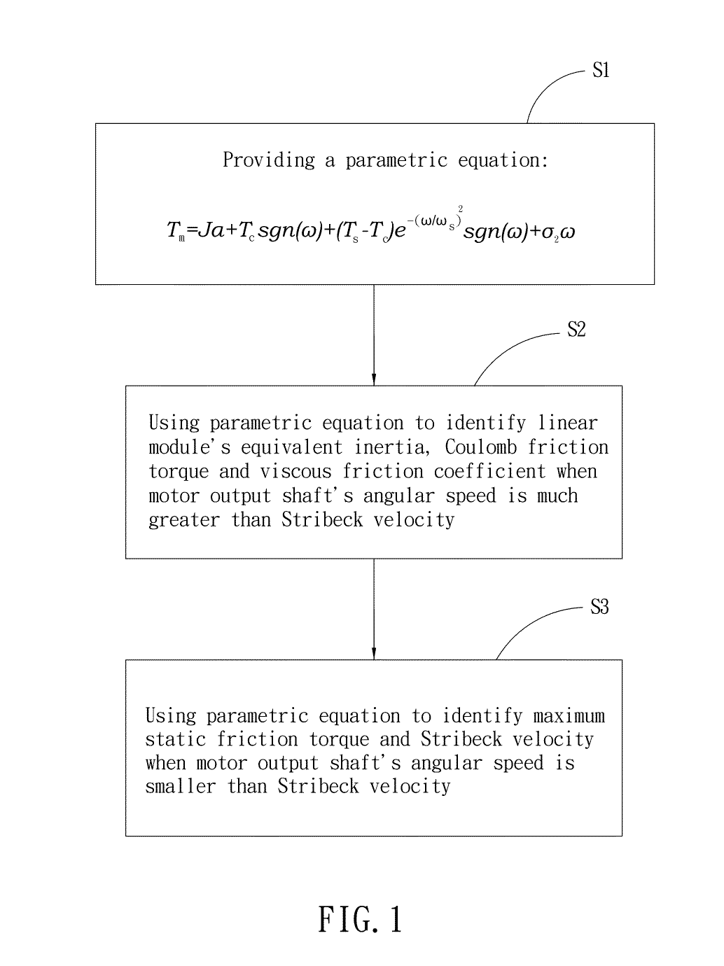

Referring to FIG. 1, according to the present invention, a method for identifying a friction parameter for linear module comprises a step a) S1, a step b) S2, and a step c) S3.

In the step a) S1, a first equation is derived from a LuGrefriction model. The first equation is written as T_{f}=T_{c}sgn(ω)+(Tₛ−T_{c})e^{-(ω/ω}^{ₛ}⁾^{²} sgn(ω)+σ₂ω, where T_{f} is the linear module's friction torque, T_{c} is a Coulomb friction torque, ω is an angular speed of the output shaft of the motor, Tₛ is a maximum static friction torque, ωₛ is Stribeck velocity, and σ₂ is a viscous friction coefficient. Then a second equation is also derived from the LuGrefriction model. The second equation is Tₘ=Jα+T_{f}, where Tₘ is the motor's output torque, J is the linear module' equivalent inertia, and α is an angular acceleration of an output shaft of the motor. Then by combining the first and second equations, a parametric equation is obtained. The parametric equation is

Tₘ=Jα+T_{c}sgn(ω)+(Tₛ−T_{c})e^{-(ω/ω}^{ₛ}⁾^{²}sgn(ω)+σ₂ω.

In the step b) S2, when ω is much greater than ωₛ, the linear module is in the high-speed segment. At this time, (Tₛ−T_{c})e^{-(ω/ω}^{ₛ}⁾^{²} sgn (ω) is close to 0, so the parametric equation can be simplified into Tₘ=Jα+T_{c}sgn(ω)+σ₂ω. Therein, Tₘ and ω are directly measured. After ω is identified, α can be in turn identified by performing differentiation once. At this time, there are two alternatives to identify J, T_{c} and σ₂.

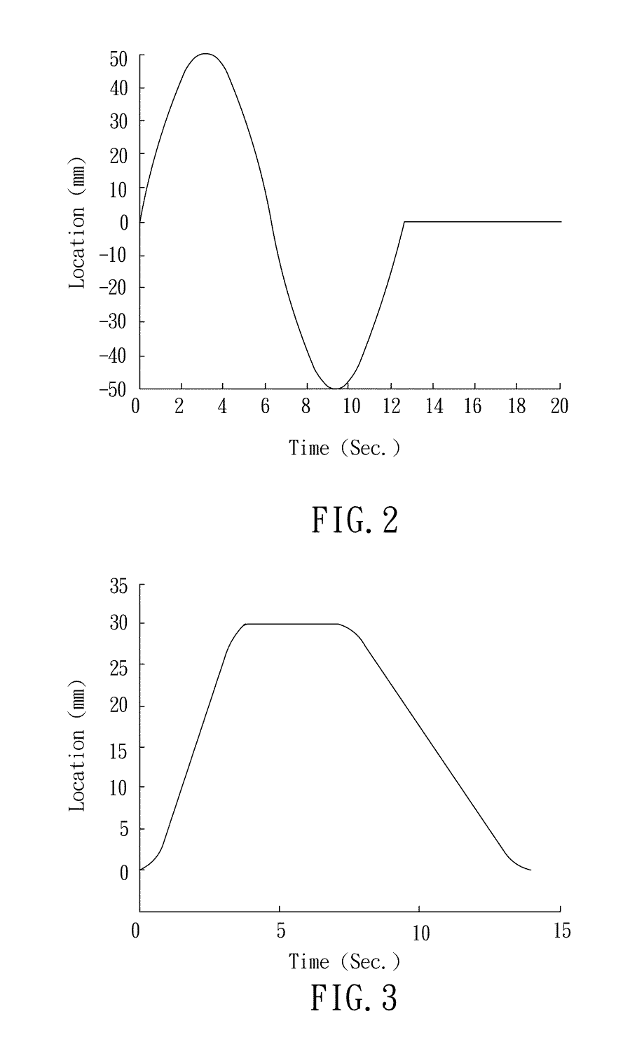

In a first approach, sinusoidal velocity planning (as shown in FIG. 2) is used to arrange the plural measuring signals in the high-speed segment into the following matrix:

$$[ \begin{matrix}{T}_{m}^{1} \\ {T}_{m}^{2} \\ ⋮ \\ {T}_{m}^{N}\end{matrix} ] = [ \begin{matrix}{α}_{1} & 1 & {ω}_{1} \\ {α}_{2} & 1 & {ω}_{2} \\ ⋮ & ⋮ & ⋮ \\ {α}_{N} & 1 & {ω}_{N}\end{matrix} ] [ \begin{matrix}J \\ {T}_{c} \\ {σ}_{2}\end{matrix} ] ,$$

and making Y=AX, where Y is a vector composed of the motor's output torques, A is a matrix composed of the motor output shaft's angular acceleration and the motor output shaft's angular speed, and X is a vector composed of the parameters to be identified. At this time, the previous matrix can be rewritten into:

$$[ \begin{matrix}J \\ {T}_{c} \\ {σ}_{2}\end{matrix} ] = {( \begin{matrix}{A}^{T} & A\end{matrix} )}^{- 1} {A}^{T} Y ,$$

and by using the least square method, J, T_{c} and σ₂ can be obtained.

The second approach is to use trapezoidal velocity planning (as shown in FIG. 3) to define ωₚ, ωₙ, Tₚ, and Tₙ, where ωₚ is the linear module's angular speed during departure within the fixed-velocity segment, |ωₚ|>>wₛ, wₙ is the linear module's angular speed during return within the fixed-velocity segment, |ωₙ|>>ωₛ, Tₚ is the motor's output torque during the linear module's departure within the fixed-velocity segment, and Tₙ the motor's output torque during the linear module's return within the fixed-velocity segment. Since the angular speed α in the fixed-velocity segment is 0, the parametric equation of the step a) can be rewritten into

$$\{ \begin{matrix}{T}_{p} = {T}_{c} + {σ}_{2} {ω}_{p} \\ {T}_{n} = - {T}_{c} + {σ}_{2} {ω}_{n}\end{matrix} ,$$

so as to derive

$${σ}_{2} = \frac{{T}_{p} + {T}_{n}}{{ω}_{p} + {ω}_{n}} , {T}_{c} = {T}_{p} - \frac{{T}_{p} + {T}_{n}}{{ω}_{p} + {ω}_{n}} \times {ω}_{p} .$$

After σ₂ and T_{c} are derived,

$$J = \frac{{T}_{m} - {T}_{c} sgn ( ω ) - {σ}_{2} ω}{α}$$

can be obtained by using the measuring signals in the high-speed segment (ω is much greater than ωₛ) and the parametric equation of the step a).

In the step c) S3, when ω is smaller than ωₛ or close to ωₛ, the linear module is located in the low-speed segment interval. At this time, (Tₛ−T_{c})e^{-(ω/ω}^{ₛ}⁾^{²} sgn(ω) is not 0. Since J, T_{c} and σ₂ have been identified in the step b), there are only Tₛ and ωₛ remaining in the parametric equation as unknown parameters. At this time, two alternatives may be considered, as stated below.

As a first approach, the unknown parameters and the parameters identified in step b) are separated and their logarithms are taken, respectively, so as to make the parametric equation of the step a) become a linear equation that is written as p=q−ω²·r, where p=ln(Tₘ−Jα−T_{c}sgn(ω)−σ₂ω), and q=ln(Tₛ−T_{c}), r=1/(ωₛ)². Since p can be determined by substituting the known parameters, and ω can be found through direct measurement, q and r can be easily obtained, and in turn Tₛ and ωₛ can be identified.

As a second approach, the parametric equation is first rewritten into: Tₘ−Jα=(Tₛ−T_{c})e^{-(ω/ω}^{ₛ}⁾^{²}sgn(ω)+T_{c}sgn(ω)+σ₂ ω, and then Tₛ and ω, are identified by means of curve fitting. At this time, there are only two parameters remaining unknown, so the process of curve fitting can be significantly simplified.

To sum up, the disclosed method divides the linear module's moving velocity into a high-speed segment interval and a low-speed segment interval, so that by making the linear module perform only one reciprocating movement, all the relevant parameters can be identified. As compared to the prior art, the present invention makes identification of the parameters much more easier and much more feasible in practice.

What is claimed is:

1. A method for identifying friction parameters for a linear module, the method comprising steps of:
a) providing a parametric equation written as:
Tₘ=Jα+T_{c}sgn(ω)+(Tₛ−T_{c})e^{-(ω/ω}^{ₛ}⁾^{²}sgn (ω)+σ₂ω, where Tₘ is an output torque of a motor, J is an equivalent inertia of the linear module, a is an angular acceleration of an output shaft of the motor, T_{c} is a Coulomb friction torque, ω is an angular speed of the output shaft of the motor, Tₛ is a maximum static friction torque, ωₛ is a Stribeck velocity, and σ₂ is a viscous friction coefficient;
b) using the parametric equation to identify J, T_{c} and σ₂ when ω is much greater than ωₛ; and
c) using the parametric equation and the parameters identified in the step b) to identify Tₛ and ωₛ when ω is smaller than ωₛ.

2. The method of claim 1, wherein in the step c), Tₛ and ωₛ are identified by means of curve fitting.

3. The method of claim 1, wherein in the step c), the parameters to be identified and the parameters identified in the step b) are divided, taking logarithms of the both so as to obtain a linear equation, and using the linear equation to identify Tₛ and ωₛ, in which the linear equation is written as p=q−ω²·r, where p is ln(Tₘ−Jα−T_{c}sgn(ω)−σ₂ω), and q is ln(Tₛ−T_{c}), r is 1/(ωₛ)².

4. The method of claim 1, wherein in the step b), J, T, and σ₂ are identified using sinusoidal velocity planning, in which
$$[ \begin{matrix}J \\ {T}_{c} \\ {σ}_{2}\end{matrix} ] = {( \begin{matrix}{A}^{T} & A\end{matrix} )}^{- 1} {A}^{T} Y ,$$
where A is
$$[ \begin{matrix}{α}_{1} & 1 & {ω}_{1} \\ {α}_{2} & 1 & {ω}_{2} \\ ⋮ & ⋮ & ⋮ \\ {α}_{N} & 1 & {ω}_{N}\end{matrix} ] ,$$
and Y is
$$[ \begin{matrix}{T}_{m}^{1} \\ {T}_{m}^{2} \\ ⋮ \\ {T}_{m}^{N}\end{matrix} ] .$$

5. The method of claim 1, wherein in the step b), J, T, and σ₂ are identified using trapezoidal velocity planning, in which J=
$$\frac{{T}_{m} - {T}_{c} sgn ( ω ) - {σ}_{2} ω}{α} , {T}_{c} = {T}_{p} - \frac{{T}_{p} + {T}_{n}}{{ω}_{p} + {ω}_{n}} \times {ω}_{p} , {σ}_{2} = \frac{{T}_{p} + {T}_{n}}{{ω}_{p} + {ω}_{n}} ,$$
where ωₚ is an angular speed of the linear module during departure within a fixed-velocity segment, |ωₚ|>>wₛ, wₙis an angular speed of the linear module during return within the fixed-velocity segment, |ωₙ>>ωₛ, Tₚ is a torque output by the motor's during the linear module's departure within the fixed-velocity segment, and Tₙ is a torque output by the motor during the linear module's return within the fixed-velocity segment.
